(19) United States
(12) Patent Application Publication
(10) Pub. No.: US 2026/0344586 A1
(43) Pub. Date: Nov. 5, 2026

(54) LEAF BLOWER

(71) Applicant: HUSQVARNA AB, Huskvarna (SE)

(72) Inventors: Peter KVIST, Huskvarna (SE); Elias KARDELL, Huskvarna (SE); Helen EKEGREN, Huskvarna (SE); Henrik VANGO, Huskvarna (SE)

(21) Appl. No.: 19/484,989

(22) PCT Filed: Apr. 8, 2024
(86) PCT No.: PCT/SE2024/050330

§ 371 Date: Nov. 17, 2025

(30) Foreign Application Priority Data
May 23, 2023 (SE) 2350619-9

(51) Int. Cl. A01G 20/47

(52) U.S. Cl. CPC A01G 20/47

(57) ABSTRACT

A leaf blower (10) is disclosed comprising an air inlet duct (1), an air outlet duct (2), an outer body (4) attached to each of the air inlet duct (1) and the 10 air outlet duct (2), and a motor/fan unit (5) comprising a fan duct (3), a motor unit (6), and a fan unit (7). The motor unit (6) and the fan unit (7) are arranged at least partially inside the fan duct (3). The fan duct (3) is arranged between the air inlet duct 29(1 ) and the air outlet duct (2) and is structurally supported relative to the outer body (4) completely via the air inlet duct (1) and the air outlet duct (2).

### TECHNICAL FIELD

The present disclosure relates to a leaf blower, i.e., a device that can be used to blow leaves and debris from areas.

### BACKGROUND

A leaf blower is a handheld or backpack device with the primary function of blowing leaves, debris, dust, grass clippings, and the like from lawns, driveways, sidewalks, and the like areas. They are commonly used by homeowners, landscapers, and groundskeepers to maintain the cleanliness and appearance of spaces. Moreover, in areas with light snowfall, a leaf blower can be used to remove snow quickly and easily from sidewalks, driveways, and other outdoor areas. In conclusion, leaf blowers are versatile tools that can make maintaining outdoor spaces easier and more efficient.

Leaf blowers comprise a fan powered by a motor, such as an electric motor or a combustion engine. Leaf blowers are typically self-contained handheld units or backpack mounted units with a handheld outlet nozzle.

Noise and vibration are problems associated with leaf blowers. A leaf blower generates a lot of noise and vibrations due to the rapid movement of air through its fan. The fan spin rapidly creating a strong current of air that is forced out of the nozzle at high speeds. This rapid movement of air creates turbulence, which in turn generates noise and vibrations. Noise generated by a leaf blower is partly due to the rapid changes in air pressure caused by the turbulent airflow. As the air moves through the fan, it is rapidly compressed and then decompressed as it is expelled through the nozzle. This causes pressure waves in the air that we perceive as sound.

The vibrations generated by a leaf blower are also a result of the turbulent airflow. The force of the moving air causes the entire machine to vibrate, and this vibration is transmitted to a handle and other parts of the machine that come into contact with the user's body.

In addition, mechanical factors contribute to the noise and vibrations of a leaf blower, and the design and construction of the machine also play a role. For example, the operation of the motor and the rapid rotation of the fan generate sound and vibrations which is transmitted to the handle and other parts of the machine that come into contact with the user's body.

Electrically powered leaf blowers, i.e. leaf blowers comprising a fan powered by an electric motor, generally generate less noise and less vibration than leaf blowers comprising a fan powered by a combustion engine. However, also electrically powered leaf blowers generate high levels of noise and vibration, and noise and vibration are also problems associated with electrically powered leaf blowers.

Another problem associated with the design of a leaf blower is to obtain a low weight of the leaf blower. A lighter leaf blower is generally easier to handle and manoeuvre, which can be especially important for prolonged use or for users with limited physical strength. Moreover, a lighter blower puts less strain on the user's arms, shoulders, and/or back, which can reduce the risk of fatigue, strain, or injury.

Moreover, it is an advantage if products, such as leaf blowers, have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by a leaf blower comprising an air inlet duct, an air outlet duct, an outer body attached to each of the air inlet duct and the air outlet duct, and a motor/fan unit comprising a fan duct, a motor unit, and a fan unit. The motor unit and the fan unit are arranged at least partially inside the fan duct. The fan duct is arranged between the air inlet duct and the air outlet duct and is structurally supported relative to the outer body completely via the air inlet duct and the air outlet duct.

Since the fan duct is structurally supported relative to the outer body completely via the air inlet duct and the air outlet duct, a lower transfer of sound and vibrations is provided radially from the fan duct to the outer body of the leaf blower. In this manner, conditions are provided for a lower transfer of noise to the surroundings and a reduced transfer of vibrations from the motor/fan unit to the outer body and thereby also from the motor/fan unit to a user of the leaf blower.

That is, in prior art leaf blowers, the motor/fan unit is normally squeezed radially between parts of an outer body of the leaf blower which means that sound and vibrations can propagate straight in radial directions from the motor/fan unit to the outer body of the leaf blower. However, by structurally supporting the fan duct relative to the outer body completely via the air inlet duct and the air outlet duct, such propagation of sound and vibration can be blocked by a spacing formed between the fan duct and the outer body of the leaf blower.

Moreover, some prior art leaf blowers utilize a number of anti-vibration elements in rubber for radially supporting the motor/fan unit relative to an outer body of the leaf blower. However, the high frequency of the vibrations makes such anti-vibration elements inefficient in attenuating the vibrations. Moreover, such anti-vibration elements add costs, complexity, and weight to a leaf blower.

Accordingly, due to the features of the leaf blower, conditions are provided for low levels of noise and vibration from the leaf blower while ensuring a low weight of the leaf blower. In addition, conditions are provided for a leaf blower having low complexity and low manufacturing costs.

In addition, since the fan duct is structurally supported relative to the outer body completely via the air inlet duct and the air outlet duct, a leaf blower is provided having conditions and characteristics suitable for being assembled in a cost-efficient manner.

Accordingly, a leaf blower is provided overcoming, or at least alleviating, at least some of the above-mentioned problems and drawbacks. As a result, the above-mentioned object is achieved.

Optionally, the motor unit and the fan unit are structurally supported relative to the outer body completely via the fan duct. Thereby, a low transfer of sound and vibration can be ensured from the motor unit and the fan unit to the outer body of the leaf blower.

Optionally, the leaf blower comprises a number of stator blades, and wherein the motor unit is mounted to the fan duct via the number of stator blades. Thereby, an efficient operation of the leaf blower can be ensured. Moreover, since the fan duct is structurally supported relative to the outer body completely via the air inlet duct and the air outlet duct, it can be ensured that the vibrations transferred from the motor unit to the fan duct via the number of stator blades cannot be directly transferred radially to the outer body of the leaf blower.

Optionally, the number of stator blades and the fan duct are formed by of one piece of continuous material. Thereby, conditions are provided for a rigid and durable motor/fan unit. Optionally, each of the air inlet duct, the air outlet duct, and the fan duct is made from a polymeric material. Thereby, conditions are provided for a rigid and durable leaf blower having a low weight.

Optionally, the fan unit is arranged to generate an airflow having an airflow direction upon being rotated by the motor unit around a rotation axis, and wherein the fan duct is clamped between the air inlet duct and the air outlet duct in directions parallel to the airflow direction. Thereby, it can be further ensured that low levels of sound and vibrations is transferred radially from the fan duct to the outer body of the leaf blower. Moreover, a leaf blower is provided having conditions and characteristics suitable for being assembled in a cost-efficient manner. This is because clamping of the fan duct between the air inlet duct and the air outlet duct circumvents the need for attaching the fan duct to the air inlet duct and the fan duct to the air outlet duct with a number of fastening elements.

Optionally, the fan duct comprises an outlet mounting portion mounted to a mounting portion of the air outlet duct. Thereby, a low transfer of sound and vibration can be provided from the fan duct to the air outlet duct.

Optionally, the outlet mounting portion of the fan duct is inserted into the mounting portion of the air outlet duct. Thereby, a low transfer of sound and vibration from the fan duct to the air outlet duct can be further ensured. Moreover, a leaf blower is provided having conditions and characteristics suitable for being assembled and manufactured in a cost-efficient manner. This is because the insertion of the outlet mounting portion of the fan duct into the mounting portion of the air outlet duct can circumvent the need for attaching the outlet mounting portion of the fan duct to the mounting portion of the air outlet duct by the use of a number of fastening elements. In addition, a leaf blower is provided in which the outlet mounting portion of the fan duct can be sealed relative to the mounting portion of the air outlet duct in a simple and efficient manner.

Optionally, the fan duct comprises an inlet mounting portion mounted to a mounting portion of the air inlet duct. Thereby, a low transfer of sound and vibration can be provided from the fan duct to the air inlet duct.

Optionally, the inlet mounting portion of the fan duct is inserted into the mounting portion of the air inlet duct. Thereby, a low transfer of sound and vibration from the fan duct to the air inlet duct can be further ensured. Moreover, a leaf blower is provided having conditions and characteristics suitable for being assembled and manufactured in a cost-efficient manner.

This is because the insertion of the inlet mounting portion of the fan duct into the mounting portion of the air inlet duct can circumvent the need for attaching the inlet mounting portion of the fan duct to the mounting portion of the air inlet duct by the use of a number of fastening elements. In addition, a leaf blower is provided in which the inlet mounting portion of the fan duct can be sealed relative to the mounting portion of the air inlet duct in a simple and efficient manner.

Optionally, the outer body is attached to each of the air inlet duct and the air outlet duct by being clamped to the air inlet duct and the air outlet duct respectively. Thereby, a leaf blower is provided having conditions and characteristics suitable for being assembled in a cost-efficient manner. This is because clamping of the outer body to the air inlet duct and the air outlet duct respectively circumvents the need for attaching the outer body to the air inlet duct and the outer body to the air outlet duct with a number of fastening elements.

Optionally, the leaf blower is a hand-held leaf blower comprising a handle portion for supporting the leaf blower during use thereof. Thereby, a hand-held leaf blower is provided having conditions for a low transfer of vibrations from the fan duct to the handle portion of the leaf blower while having conditions for obtaining a low weight and a low complexity of the leaf blower.

Optionally, wherein the motor unit comprises an electric motor. Thereby, an environmentally friendly leaf blower is provided having conditions for generating a low amount of noise and vibration during operation.

Optionally, the fan unit comprises an axial fan. Thereby, an efficient operation of the motor/fan unit can be ensured while obtaining a low transfer of noise and vibration radially from the fan duct to the outer body of the leaf blower.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a perspective view of a leaf blower according to some embodiments,

FIG. 2 illustrates a first cross section of the leaf blower illustrated in FIG. 1,

FIG. 3 illustrates a perspective view of a motor/fan unit of the leaf blower illustrated in FIG. 1 and FIG. 2 in which a section of a fan duct of the motor/fan unit has been removed for reasons of visibility,

FIG. 4 illustrates a side view of an air inlet duct, an air outlet duct, and a motor/fan unit of the leaf blower according to the embodiments illustrated in FIG. 1-FIG. 3, wherein the components are illustrated in a disassembled state,

FIG. 5 illustrates a side view of the air inlet duct, the air outlet duct, and the motor/fan unit of the leaf blower according to the embodiments illustrated in FIG. 1-FIG. 3, wherein the components are illustrated in an assembled state, and

FIG. 6 illustrates a second cross section of the leaf blower illustrated in FIG. 1.

### DETAILED DESCRIPTION

Aspects of the present invention will now be described more fully. Like reference signs refer to like elements throughout. Well-known functions or constructions will not necessarily be described in detail for brevity and/or clarity.

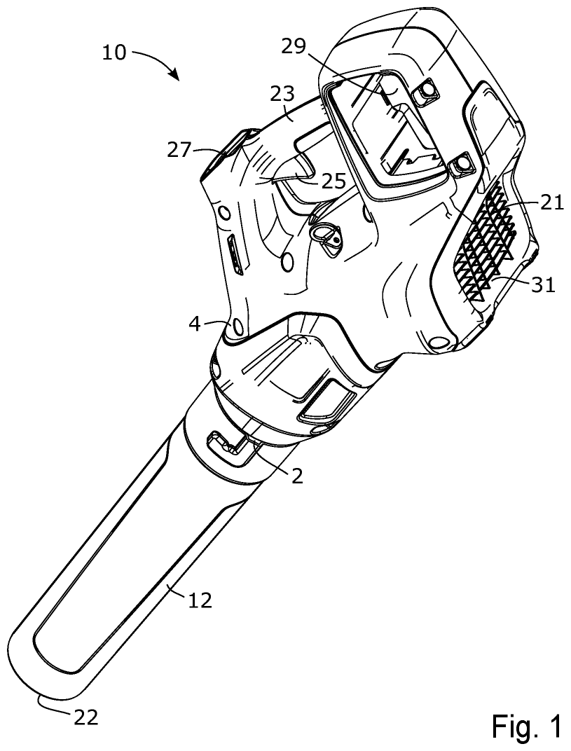

FIG. 1 illustrates a perspective view of a leaf blower 10 according to some embodiments. The leaf blower 10, as referred to herein, may also be referred to as a debris blower. The primary function of the leaf blower 10 is to blow leaves, debris, dust, grass clippings, and the like from lawns, driveways, sidewalks, and the like areas.

According to the illustrated embodiments, the leaf blower 10 is a hand-held leaf blower comprising a handle portion 23 for supporting the leaf blower 10 during use thereof. According to further embodiments, the leaf blower 10 may be a backpack mounted leaf blower and may thus be referred to as a backpack leaf blower, a backpack debris blower, or the like.

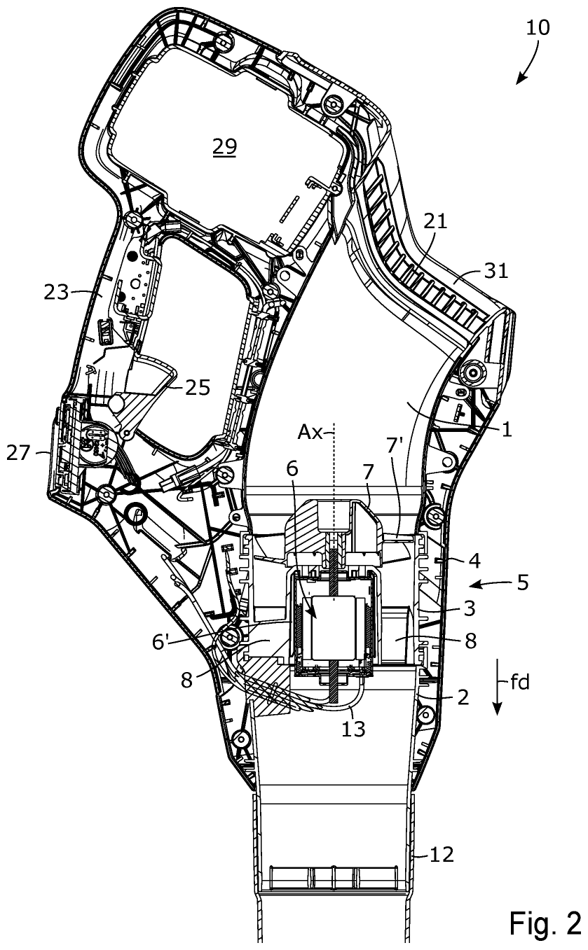

FIG. 2 illustrates a first cross section of the leaf blower 10 illustrated in FIG. 1. As is further explained herein, the leaf blower 10 comprises an air inlet duct 1, an air outlet duct 2, and an outer body 4 attached to each of the air inlet duct 1 and the air outlet duct 2. The leaf blower 10 further comprises a motor/fan unit 5. The motor/fan unit 5 comprises a fan duct 3, a motor unit 6, and a fan unit 7.

As seen in FIG. 2, the motor unit 6 and the fan unit 7 are arranged at least partially inside the fan duct 3. Moreover, the fan duct 3 is arranged between the air inlet duct 1 and the air outlet duct 2. The motor unit 6 is configured to rotate the fan unit 7 around a rotation axis Ax. The fan unit 7 is arranged to generate an airflow having an airflow direction fd through the motor/fan unit 5 upon being rotated by the motor unit 6 around the rotation axis Ax.

According to the illustrated embodiments, the fan unit 7 comprises an axial fan, i.e., a type of fan that uses a set of fan blades 7′ to create airflow in a parallel or axial direction relative to the rotation axis Ax of the fan unit 7. An axial fan is sometimes also referred to as a propeller fan. According to the illustrated embodiments, the fan unit 7 may comprise another type of fan, such as for example a centrifugal fan.

According to the illustrated embodiments, the motor unit 6 comprises an electric motor. The electric motor comprises a stator and a rotor, wherein the rotor is connected to the fan unit 7 via an output shaft. The stator, the rotor, and the output shaft have not been provided with reference signs in FIG. 2 for reasons of brevity and clarity. Moreover, according to further embodiments, the motor unit 6 of the leaf blower 10 may comprise another type of motor than an electric motor, such as an internal combustion engine.

As is indicated in FIG. 1 and FIG. 2, according to the illustrated embodiments, the leaf blower 10 comprises a battery compartment 29. The battery compartment 29 is configured to accommodate a battery pack for providing electricity to the electric motor of the motor unit 6 via a number of electric cables 13. The number of electric cables 13 is indicated in FIG. 2. The leaf blower 10 may comprise another type of means for providing electricity to the electric motor of the motor unit 6 as an alternative to, or in addition to, the battery compartment 29, such as an electrical connector configured to be connected to an electric supply cable, or the like.

Moreover, as is seen in FIG. 1 and FIG. 2, the leaf blower 10 comprises a user interface unit 27. According to the illustrated embodiments, the leaf blower 10 can be transferred between an activated state and a deactivated state via the user interface unit 27. The user interface unit 27 may comprise a number of input units, such as a number of buttons and/or a number of switches allowing such a transfer. Moreover, the leaf blower 10 may comprise a number of output units, such as a number of light emitting units, a number of light emitting diodes, a display, or the like. The number of output units may indicate a current activation status of the leaf blower 10, a current state of charge of a battery pack connected to the battery compartment 29, and the like information.

As seen in FIG. 1 and FIG. 2, according to the illustrated embodiments, the leaf blower 10 comprises a throttle actuator 25 arranged on the handle portion 23 of the leaf blower 10.

According to the illustrated embodiments, a user may initiate operation of the motor/fan unit 5 of the leaf blower 10 by transferring the leaf blower 10 to the activated state via the user interface unit 27 and then pressing the throttle actuator 25. According to further embodiments, the leaf blower 10 may lack a user interface unit 27. According to such embodiments, a user may be able to initiate operation of the motor/fan unit 5 simply by connecting the leaf blower 10 to an electrical power source, for example by inserting a battery pack into the battery compartment 29, and then press the throttle actuator 25.

Moreover, the leaf blower 10 may comprise a motor control unit configured to control the power output of the motor/fan unit 5 based on a degree of displacement of the throttle actuator 25. Such motor control unit may be configured to control the power output of the motor/fan unit 5 my regulating the amount of electricity supplied to the motor unit 6 via the number of electric cables 13.

As is indicated in FIG. 1, the leaf blower 10 comprises an air inlet 21 and an air outlet 22. The air inlet 21 is also indicated in FIG. 2. The motor/fan unit 5 is configured to generate an airflow in a direction from the air inlet 21 to the air outlet 22 during operation. As mentioned, the fan duct 3 of the motor/fan unit 5 is arranged between the air inlet duct 1 and the air outlet duct 2. The motor/fan unit 5 is thus configured to generate an airflow in a direction from the air inlet duct 1 to the air outlet duct 2 during operation.

Moreover, according to the illustrated embodiments, the leaf blower 10 comprises an inlet member 31 arranged at an inlet portion of the air inlet duct 1. The inlet member 31 comprises a grid arranged to prevent larger objects from entering the air inlet duct 1. Moreover, according to the illustrated embodiments, the leaf blower 10 comprises an outlet nozzle 12. As seen in FIG. 1 and FIG. 2, the outlet nozzle 12 is attached to the air outlet duct 2 of the leaf blower 10. According to the illustrated embodiments, the outlet nozzle 12 is formed as an elongated tube.

In embodiments in which the leaf blower 10 is a backpack mounted leaf blower, the leaf blower may comprise a flexible connection between the air outlet duct 2 and an air outlet nozzle. Such an air outlet nozzle may be provided with a handle such that a user can direct the airflow from the air outlet nozzle in wanted directions, while the air inlet duct 1, the air outlet duct 2, and the motor/fan unit 5 may be accommodated in a backpack mounted part of the leaf blower.

According to the illustrated embodiments, a user may grab the handle portion 23, and possibly also a portion of the outer body 4 or the air outlet nozzle 12, to direct the airflow from the air outlet nozzle 12 in wanted directions. Moreover, also according to the illustrated embodiments, the air outlet nozzle 12 may comprise a handle.

As explained above, the outer body 4 of the leaf blower 10 is attached to each of the air inlet duct 1 and the air outlet duct 2. Moreover, according to embodiments herein, the fan duct 3 is structurally supported relative to the outer body 4 completely via the air inlet duct 1 and the air outlet duct 2.

Thereby, as is further explained herein, a low transfer of sound and vibrations is provided from the fan duct 3 to the outer body 4 of the leaf blower 10, especially in radial directions from the fan duct 3, i.e., in directions perpendicular to the rotation axis ax of the fan unit 7. The feature that the fan duct 3 is structurally supported relative to the outer body 4 completely via the air inlet duct 1 and the air outlet duct 2 may also be expressed as that the fan duct 3 is structurally supported relative to the outer body 4 only via the air inlet duct 1 and the air outlet duct 2.

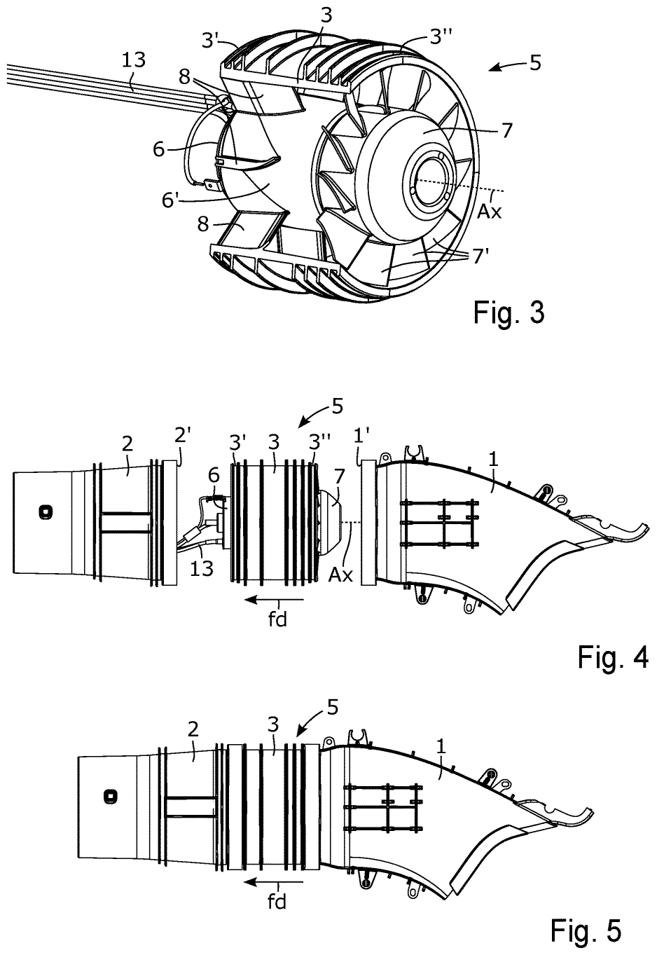

FIG. 3 illustrates a perspective view of the motor/fan unit 5 of the leaf blower 10 illustrated in FIG. 1 and FIG. 2 in which a section of the fan duct 3 has been removed for reasons of visibility. In FIG. 3, the fan unit 7 including the fan blades 7′ thereof can be clearly seen. Moreover, in FIG. 3, the rotation axis ax of the fan unit 7 is indicated.

Moreover, as is clearly seen in FIG. 3, the motor/fan unit 5 comprises number of stator blades 8. Two stator blades 8 are also seen and indicated in FIG. 2. The stator blades 8 are arranged downstream of the number of fan blades 7′ of the fan unit 7 as seen relative to the airflow direction fd through the motor/fan unit 5.

As seen in FIG. 2 and FIG. 3, the motor unit 6 is mounted to the fan duct 3 via the number of stator blades 8. That is, in more detail, according to the illustrated embodiments, the motor/fan unit 5 comprises a motor mount section 6′ wherein the number of stator blades 8 is attached to the motor mount section 6′, and wherein the motor unit 6 is arranged and is supported inside the motor mount section 6′.

According to the illustrated embodiments, the motor mount section 6′, the number of stator blades 8, and the fan duct 3 are formed by of one piece of a continuous polymeric material. Moreover, according to the illustrated embodiments, each of the air inlet duct 1, the air outlet duct 2, and the fan duct 3 is made from a polymeric material. According to further embodiments, two or more of the motor mount section 6′, the number of stator blades 8, and the fan duct 3 may be formed by separate pieces of materials being joined together. Moreover, one or more of the motor mount section 6′, the number of stator blades 8, the fan duct 3, the air inlet duct 1, and the air outlet duct 2 may be formed by another material than a polymeric material, such as metal, for example an aluminium alloy.

As understood from the above, since the motor unit 6 supports the fan unit 7 via the output shaft of the motor unit 6, according to the illustrated embodiments, the motor unit 6 and the fan unit 7 are structurally supported relative to the outer body 4 completely via the fan duct 3. The feature that the motor unit 6 and the fan unit 7 are structurally supported relative to the outer body 4 completely via the fan duct 3 may also be expressed as that the motor unit 6 and the fan unit 7 are structurally supported relative to the outer body 4 only via the fan duct 3.

FIG. 4 illustrates a side view of the air inlet duct 1, the air outlet duct 2, and the motor/fan unit 5 of the leaf blower 10 according to the embodiments illustrated in FIG. 1-FIG. 3, wherein these components are illustrated in a disassembled state. In FIG. 4, the rotation axis ax of the fan unit 7 as well as the airflow direction fd through the motor/fan unit 5 are indicated.

The fan duct 3 of the motor/fan unit 5 comprises an outlet mounting portion 3′ configured to be mounted to a mounting portion 2′ of the air outlet duct 2. Likewise, the fan duct 3 comprises an inlet mounting portion 3″ configured to be mounted to a mounting portion 1′ of the air inlet duct 1.

FIG. 5 illustrates a side view of the air inlet duct 1, the air outlet duct 2, and the motor/fan unit 5 of the leaf blower 10 according to the embodiments illustrated in FIG. 1-FIG. 3, wherein these components are illustrated in an assembled state.

As seen when comparing FIG. 4 and FIG. 5, according to the illustrated embodiments, the air inlet duct 1, the air outlet duct 2, and the motor/fan unit 5 are assembled by moving the components towards each other in directions parallel to the airflow direction fd. Moreover, as seen when comparing FIG. 4 and FIG. 5, according to the illustrated embodiments, the air outlet duct 2 is assembled relative to the fan duct 3 of the motor/fan unit 5 by an insertion of the outlet mounting portion 3′ of the fan duct 3 into the mounting portion 2′ of the air outlet duct 2. Likewise, the air inlet duct 1 is assembled relative to the fan duct 3 of the motor/fan unit 5 by an insertion of the inlet mounting portion 3″ of the fan duct 3 into the mounting portion 1′ of the air inlet duct 1.

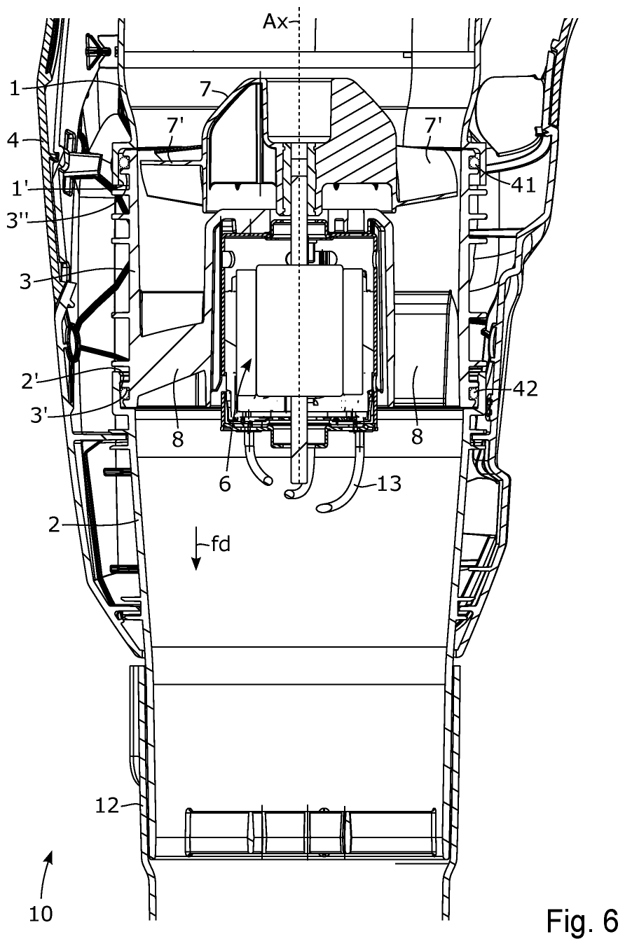

FIG. 6 illustrates a second cross section of the leaf blower 10 illustrated in FIG. 1. As is indicated in FIG. 6, the outlet mounting portion 3′ of the fan duct 3 is inserted into the mounting portion 2′ of the air outlet duct 2. Likewise, the inlet mounting portion 3″ of the fan duct 3 is inserted into the mounting portion 1′ of the air inlet duct 1.

In FIG. 6, a first sealing 41 is schematically indicated in an interface between the inlet mounting portion 3″ of the fan duct 3 and the mounting portion 1′ of the air inlet duct 1.

Likewise, a second sealing 42 is schematically indicated in an interface between the outlet mounting portion 3′ of the fan duct 3 and the mounting portion 2′ of the air outlet duct 2. In this manner, the fan duct 3 of the motor/fan unit 5 can be sealed relative to the air inlet duct 1 and the air outlet duct 2 respectively in a simple and efficient manner. However, according to further embodiments, the leaf blower 10 may lack one or both of the first and second sealings 41, 42.

According to the illustrated embodiments, the fan duct 3 is clamped between the air inlet duct 1 and the air outlet duct 2 in directions parallel to the airflow direction fd. According to the illustrated embodiments, the airflow direction fd coincides with the rotation axis ax of the fan unit 7. The fan duct 3 is thus clamped between the air inlet duct 1 and the air outlet duct 2 in directions parallel to the rotation axis ax of the fan unit 7.

Furthermore, according to the illustrated embodiments, the motor/fan unit 5 is structurally supported, i.e., held in place, relative to the outer body 4 of the leaf blower 10 completely via the air inlet duct 1 and the air outlet duct 2 without the use of any fastening elements, such as screws, bolts, or rivets, between the fan duct 3 and the air inlet duct 1 and between the fan duct 3 and the air outlet duct 2.

Moreover, according to the illustrated embodiments, the outer body 4 is attached to each of the air inlet duct 1 and the air outlet duct 2 by being clamped to the air inlet duct 1 and the air outlet duct 2 respectively. In other words, according to the illustrated embodiments, the each of the air inlet duct 1 and the air outlet duct 2 is structurally supported relative to the outer body 4 of the leaf blower 10 without the use of any fastening elements, such as screws, bolts, or rivets, between the outer body 4 and the air inlet duct 1 and between the outer body 4 and the air outlet duct 2.

In this manner, a low transfer of sound and vibrations is provided between the motor/fan unit 5 and the outer body 4 of the leaf blower 10. Moreover, as is best seen in FIG. 1 and FIG. 2, according to the illustrated embodiments, the handle portion 23 forms part of the outer body 4 of the leaf blower 10. Accordingly, due to the above-described features, a low transfer of vibrations is provided between the motor/fan unit 5 and the handle portion 23 of the leaf blower 10.

In addition, due to the above-described features, a leaf blower 10 is provided having conditions and characteristics suitable for being assembled and manufactured in a cost-efficient manner.

The feature that the fan duct 3 is structurally supported relative to the outer body 4 completely via the air inlet duct 1 and the air outlet duct 2 means that the leaf blower 10 comprises no further arrangements or parts which structurally supports the fan duct 3 relative to the outer body 4 than via the air inlet duct 1 and the air outlet duct 2. Since the fan duct 3 is structurally supported relative to the outer body 4 completely via the air inlet duct 1 and the air outlet duct 2, a low transfer of sound and vibrations is provided in radial directions from the motor/fan unit 5 to the outer body 4 of the leaf blower 10. According to the illustrated embodiments, the radial directions from the motor/fan unit 5 corresponds to directions perpendicular to the rotation axis ax of the fan unit 7.

The arrangement of the fan duct 3 relative to the air inlet duct 1 and the air outlet duct 2 according to the illustrated embodiments may be referred to as an axial arrangement of the fan duct 3 relative to the air inlet duct 1 and the air outlet duct 2 because the fan duct 3 is axially clamped between the air inlet duct 1 and the air outlet duct 2.

In prior art leaf blowers, the motor/fan unit is normally radially supported relative to an outer body of the leaf blower via a number of components and elements arranged between the motor/fan unit and the outer body radially outside of the motor/fan unit. This means that sound and vibrations can propagate straight in radial directions from the motor/fan unit to the outer body of the leaf blower.

Accordingly, by structurally supporting the fan duct 3 relative to the outer body 4 completely via the air inlet duct 1 and the air outlet duct 2, such propagation of sound and vibration can be blocked by a spacing formed between the fan duct 3 and the outer body 4 of the leaf blower 10. That is, since the fan duct 3 is structurally supported relative to the outer body 4 completely via the air inlet duct 1 and the air outlet duct 2, a spacing is formed between the fan duct 3 and the outer body 4 which fully surrounds the fan duct 3, i.e., which fully encloses the fan duct 3 in a plane perpendicular to the air flow direction fd through the motor/fan unit 5.

Moreover, some prior art leaf blowers utilize a number of anti-vibration elements in rubber, a rubber-based material, or a rubber like material for radially supporting the motor/fan unit relative to an outer body of the leaf blower. However, the high frequency of the vibrations from the motor/fan unit makes such anti-vibration elements inefficient in attenuating the vibrations. Moreover, such anti-vibration elements add costs, complexity, and weight to a leaf blower.

Accordingly, as understood from the above, by structurally supporting the fan duct 3 relative to the outer body 4 completely via the air inlet duct 1 and the air outlet duct 2, the use of such anti-vibration elements is circumvented which saves costs, complexity, and weight of the leaf blower 10 while being able to obtain low levels of noise and vibration from the leaf blower 10 during use thereof.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A leaf blower comprising:
an air inlet duct
an air outlet duct,
an outer body attached to each of the air inlet duct and the air outlet duct, and
a motor/fan unit comprising a fan duct a motor unit and a fan unit,
wherein the motor unit and the fan unit are arranged at least partially inside the fan duct,
and wherein the fan duct is arranged between the air inlet duct and the air outlet duct and is structurally supported relative to the outer body completely via the air inlet duct and the air outlet duct.

2. The leaf blower according to claim 1, wherein the motor unit and the fan unit are structurally supported relative to the outer body completely via the fan duct.

3. The leaf blower according to claim 1, wherein the leaf blower comprises a number of stator blades, and wherein the motor unit is mounted to the fan duct via the number of stator blades.

4. The leaf blower according to claim 3, wherein the number of stator blades and the fan duct are formed by of one piece of continuous material.

5. The leaf blower according to claim 1, wherein each of the air inlet duct, the air outlet duct, and the fan duct is made from a polymeric material.

6. The leaf blower according claim 1, wherein the fan unit-is arranged to generate an airflow having an airflow direction upon being rotated by the motor unit-around a rotation axis, and wherein the fan duct is clamped between the air inlet duct and the air outlet duct in directions parallel to the airflow direction.

7. The leaf blower according to claim 1, wherein the fan duct comprises an outlet mounting portion mounted to a mounting portion of the air outlet duct.

8. The leaf blower according to claim 7, wherein the outlet mounting portion of the fan duct is inserted into the mounting portion of the air outlet duct

9. The leaf blower according to claim 1, wherein the fan duct comprises an inlet mounting portion mounted to a mounting portion of the air inlet duct

10. The leaf blower according to claim 9, wherein the inlet mounting portion of the fan duct is inserted into the mounting portion of the air inlet duct.

11. The leaf blower according to claim 1, wherein the outer body is attached to each of the air inlet duct and the air outlet duct by being clamped to the air inlet duct and the air outlet duct respectively.

12. The leaf blower according to claim 1, wherein the leaf blower is a hand-held leaf blower comprising a handle portion for supporting the leaf blower during use thereof.

13. The leaf blower according to claim 1, wherein the motor unit comprises an electric motor.

14. The leaf blower according to claim 1, wherein the fan unit comprises an axial fan.
